(19) United States
(12) Patent Application Publication
(10) Pub. No.: US 2015/0301789 A1
(43) Pub. Date: Oct. 22, 2015

(54) PHOTOGRAPH FRAME HAVING SOUND SOURCE OUTPUT FUNCTION, AND STORAGE MEDIUM FOR RECORDING PROGRAM WHICH PRODUCES SOUND SOURCE OUTPUT SOURCE DATA TO BE INPUT IN PHOTOGRAPH FRAME

(71) Applicant: REMEMBER PEOPLE CO., LTD, Nam-gu, Incheon (KR)

(72) Inventors: Ju Seon YOUN, Nam-gu, Incheon (KR); Kyung Taek LEE, Nam-gu, Incheon (KR)

(21) Appl. No.: 14/646,391

(22) PCT Filed: Feb. 17, 2014
(86) PCT No.: PCT/KR2014/001260

§ 371 Date: May 21, 2015

(30) Foreign Application Priority Data
Feb. 18, 2013 (KR) 10-2013-0016909

(51) Int. Cl. G06F 3/16; G09G 5/00; G06F 3/0488; G06F 3/041; G06F 3/0484

(52) U.S. Cl. CPC G06F 3/165; G06F 3/0412; G06F 3/0416; G06F 3/04847; G06F 3/0488; G09G 5/003; G06F 3/167; G09G 2354/00; G09G 2380/16

(57) ABSTRACT

The feature of the present invention is to provide a photograph frame having a sound source output function, comprising: a case (110) having thereinside a space unit (111) for receiving a photograph (10) in which at least one person's image (I1) is included; a touch panel (120) which is disposed inside the case (110), wherein the photograph (10) is secured on the upper part of the case in a stacked manner, the touch panel comprising a plurality of touch cells (121) which sense a user's touch operation being input through the upper surface of the photograph (10) and generate a touch signal; a memory unit (130) in which sound source output source data including sound source output touch region (R1) information which is configured to be matched with the form of the person's image (I1) within the entire touch region of the touch panel (120) and sound source setting information of sound source data which is matched with each of the sound source touch regions (R1), and the sound source data are stored; a control circuit unit (140) for reading the sound source output source data stored in the memory unit (130), and outputting a sound source output control signal which enables the sound source data that are matched with the corresponding sound source output touch region (R1) to be output according to the sound source setting information if the touch signal is received from the touch cells (121) being included in the sound source output touch region (R1) on the basis of the position coordinates of the touch cells (121) which have sensed the touch operation; and a speaker unit (160) for outputting the sound source data according to the control signal of the control circuit unit (140).

### TECHNICAL FIELD

The present invention relates to a photograph frame having a sound source output function and a recording medium recording a program for generating sound source output source data to be inputted to the photograph frame, and more particularly, to a photograph frame having the sound source output function, which automatically outputs the sound source data stored to be matched with respective persons, when a person's image of the photograph contained in the frame is touched, and a recording medium recording a program for generating sound source output source data to be inputted to the photograph frame such that the sound source output function is realized.

### BACKGROUND ART

Typically, photographs of an event site are taken by using a camera in order to memorize the events such as a memorial day or visit to a specific place for a long time, and the photographed image is printed and inserted in a frame, such that the image can be frequently and easily viewed. However, according to a conventional photograph frame, picture images can only be visually viewed and the site is remembered only depending on memories of a viewing person, and therefore, sense of realism is relatively weak. In order to solve this problem, a digital frame supporting moving pictures has been released: however, since an expensive liquid crystal panel for outputting moving pictures is to be provided, a manufacturing cost rises, and maintenance cost also rises because operation power for the liquid crystal panel should be consistently consumed to consistently display the images.

### DETAILED DESCRIPTION OF THE INVENTION

### Technical Problem

The present invention is developed to solve the aforementioned problem, and an objective of the present invention is to provide a photograph frame having the sound source output function, which automatically outputs the sound source data stored to be matched with respective persons, when a person's image of the photograph contained in the frame is touched, and a recording medium recording a program for generating sound source output source data to be inputted to the photograph frame such that the sound source output function is realized.

### Technical Solution

According to a feature of the present invention, there is provided a photograph frame having a sound source output function, comprising: a case 110 having therein a space unit 111 for receiving a photograph 10 in which at least one person's image I1 is included; a touch panel 120 which is disposed inside the case 110, wherein the photograph 10 is secured on the touch panel 120 in a stacked manner, and the touch panel comprises a plurality of touch cells 121 which sense a user's touch operation being input through an upper surface of the photograph 10 to generate a touch signal; a memory unit 130 in which sound source output source data including sound source output touch area R1 information, which is set to be matched with a shape of the person's image I1 within an entire touch area of the touch panel 120, and sound source setting information of sound source data, which is matched with each of the sound source output touch areas R1, and the sound source data are stored; a control circuitry 140 for reading the sound source output source data stored in the memory unit 130, and outputting a sound source output control signal which enables the sound source data that is matched with the corresponding sound source output touch area R1 to be outputted according to the sound source setting information when the touch signal is received from the touch cells 121 included in the sound source output touch area R1 on the basis of position coordinates of the touch cells 121 which have sensed the touch operation; and a speaker unit 160 for outputting the sound source data according to the control signal of the control circuitry 140.

According to another feature of the present invention, at least one control button image I2 is included in the photograph 10, the memory unit 130 further stores control signal executing source data including control signal output touch area R2 information, which is set to be matched with a shape of the a control button image I2 within the entire touch area of the touch panel 120, and control setting information of the control signal, which is matched with each of the control signal output touch areas R2, and the control signal, and the control circuitry 140 executes a function according to content of the control signal matched with the corresponding control signal output touch area R2 according to the control setting information when the touch signal is received from the touch cells 121 included in the control signal output touch area R2 on the basis of position coordinates of the touch cells 121 which have sensed the touch operation.

According to yet another feature of the present invention, the photograph frame further comprises a skin sheet unit 40 made of a transparent or semitransparent material which is secured on the photograph 10 to be stacked on the photograph 10 and covers the upper surface of the photograph 10 secured on the touch panel 120, and at least one icon image I3 is formed on the skin sheet unit 40, wherein the memory unit 130 further stores sound source output source data including output touch area R3 information, which is set to be matched with a shape of the icon image I3 within the entire touch area of the touch panel 120, and sound source setting information of the sound source data, which is matched with each of the sound source output touch areas R3, and the control signal, and the control circuitry 140 outputs a sound source output control signal for enabling the sound source data matched with the corresponding sound source output touch area R3 to be outputted according to the sound source setting information when the touch signal is received from the touch cells 121 included in the sound source output touch area R3 on the basis of position coordinates of the touch cells 121 which have sensed the touch operation.

According to a yet another feature of the present invention, there is provided a recording medium storing therein a program for generating sound source output source data to be inputted to the photograph frame 100, wherein the program is executed on a computer to perform: an image arranging step S210 in which image data of a photograph 10 including at least one person's image I1 is read and an image of the photograph 10 is arranged in a set touch area range of the touch panel 120 on a screen of an interface device 20; a sound source output touch area setting step S220 in which a sound source output touch areas (R1), which is matched with a shape of the person's image I1, is set on the basis of position coordinates of touch cells 121 within a touch area of the touch panel 120 on which the image of the photograph 10 is arranged according to a user input signal from the interface device 20; an output sound source setting step S230 in which sound source data, which is matched with each of the sound source output touch areas R1 of the person's image 11, is set among prestored sound source data according to the user input signal; and a sound source output source data generating step S240 in which the setting information, which is set in the sound source output touch area setting step S240 and the output sound source setting step S230, is stored to generate the sound source output source data.

### Advantageous Effects

According to the present invention as above:

first, while printed images are displayed as normal photograph frames during a normal use, sound source data related to a selected person such as a voice of the person or music preferred by the person is automatically outputted, when a user selects an image of the person in a photograph, such that an auditive effect as a visual effect can be realized at the same time and the sense of realism at that time can be vividly reproduced. Also, the manufacturing cost and the maintenance cost can be reduced because the image can be represented without using an expensive liquid crystal panel;

second, since the sound source data related to the corresponding person is matched with the person included in a photograph, stored, and outputted, the sound source of the person who the user prefers can be selectively played, thereby improving user convenience;

third, a matching process between sound source data and the corresponding person can be facilitated since user voices or music can be recorded using a microphone unit, which collects peripheral sound waves to generate sound source data in an electrical signal, and the generated sound source data can be stored to be matched with the image of the corresponding person; and

fourth, since a program for generating sound source output source data to be inputted to the photograph frame is installed and executed on an interface device of a smartphone, a notebook, and a personal computer (PC), etc., the interface device is linked with the interface unit of the photograph frame, sound source output touch areas are set for the persons included in the photograph on the screen, and the source data is stored to be matched with the sound source output touch areas, the user can easily change settings of the sound source output function according to the person in the corresponding photograph, and user convenience is maximized.

### DESCRIPTION OF THE DRAWINGS

FIG. 1 is a prospective view of an exterior of the photograph frame according to a preferred embodiment of the present invention;

FIG. 2 is an exploded perspective view of details of the photograph frame according to a preferred embodiment of the present invention;

FIG. 3 is a block diagram for describing operation principles of the photograph frame according to a preferred embodiment of the present invention;

FIG. 4 is a schematic diagram for describing operation principles while the photograph frame according to a preferred embodiment of the present invention is interconnected with an interface device and sound source output source data is inputted to and stored in the photograph frame;

FIG. 5 is a front view for describing operation principles of the photograph frame according to a preferred embodiment of the present invention;

FIG. 6 is a flow chart representing respective steps for generating sound source output source data according to a preferred embodiment of the present invention;

FIG. 7 is an example screen window displayed on a display means of the interface device by a program for generating the sound source output source data according to a preferred embodiment of the present invention;

FIG. 8 is an example screenshot representing an arrangement state of images in a photograph arranged on a touch area window through an image arranging step according to a preferred embodiment of the present invention; and

FIGS. 9 to 14 are examples screenshots of respective steps for generating the sound source output source data using a program for generating the sound source output source data to be inputted to the photograph frame according to a preferred embodiment of the present invention.

### BEST MODES FOR CARRYING OUT THE INVENTION

The purposes, features, and advantages of the aforementioned present invention would become more obvious through the following specification. In the following, preferred embodiments of the present invention are explained based on attached figures.

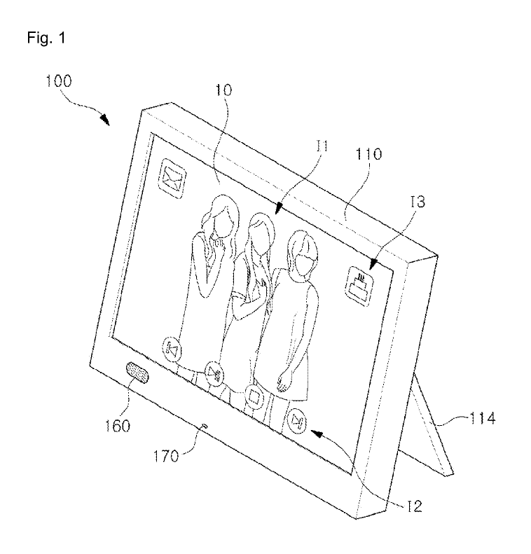

First, a configuration and a function of a photograph frame 100 according to a preferred embodiment of the present invention are explained by referring to FIGS. 1 to 5. The photograph frame 100 according to a preferred embodiment of the present invention is a photograph frame 100 with a sound source output function for enabling sound data, which is stored to be matched with respective persons, to be automatically outputted when a person's image I1 of a photograph 10 contained in a frame is touched, and comprises a case 110, a touch panel 120, a memory unit 130, a control circuitry 140, an interface unit 150, and a speaker unit 160 as shown in FIGS. 1 to 3.

The case 110 is a cover member with a space unit 111, in which the photograph 10 including therein at least one person's image I1, and comprises: a support plate 113 which supports a rear surface of the touch panel 120 and enables a touch operation through the touch panel 120; and a front cover 112 whose rim is engaged with a perimeter of the support plate 113 such that the photograph 10 secured on an upper surface of the touch panel 120 is fixed, wherein the space unit 111 with an open center portion is formed such that the image of the contained photograph 10 is displayed to outside. Also, as shown in FIG. 1, a backing unit 114, which supports the photograph frame 100 such that the photograph frame is held in an upright position, can be engaged with the rear surface of the case 110.

Here, the photograph 10 is a printed paper on which at least one person's image I1, a control button image I2, and an icon image I3 are printed, can be a printable paper used in a photo studio or a printed paper on which printed is performed through a printing means such as a color printer, and is formed in a thickness enabling touch cells 121 in the touch panel 120 to respond to a touching process, when the user touches an upper portion of the touch panel 120 through an upper surface of the photograph 10.

The touch panel 120 is an input means composed of a plurality of touch cells 121 for sensing the touch operation of the user inputted through the upper surface of the photograph 10 to generate a touch signal, is disposed inside the case 110 such that the photograph 10 is stacked thereon, and is signal-coupled with the control circuitry 140 to send the sensed touch signal to the control circuitry 140.

Here, since the photograph frame 100 according to a preferred embodiment of the present invention can sense the touch operation of the user by using the touch panel 120, on whose upper surface the photograph 10 is secured as above, while displaying a desired image through the secured photograph 10, an image display means such as a liquid crystal screen of a conventional digital frame is not required, which can reduce the manufacturing cost for fabricating the photograph frame 100 or the maintenance cost for displaying the image.

Also, while sensing the touch operation of the user, a pressurization method such as pressure-sensing and resistive methods for sensing a position, which is pressurized downward from an upper portion of the photograph 10, as well as an electrostatic method for sensing an electrostatic voltage such as a small body current flowing through a hand of a user, etc. can be adopted to sense the touch operation. Here, when realized according to the electrostatic method, the photograph 10 or a skin sheet unit 40, which is to be described in the following, are preferably configured to include an electricity delivery material capable of delivering the electrostatic voltage to the touch panel 120 such that the electrostatic voltage applied on a surface of the photograph 10 or an upper surface of the skin sheet unit 40 is delivered to the touch panel 120 through the photograph 10. Also, various sensing methods such as an ultrasonic method, an infrared method, and an optical method other than the pressurization method and the electrostatic method can be adopted as long as they are for sensing the touch operation in the field where the present invention pertains.

The memory unit 130 is a database where a program for driving the photograph frame 100 according to a preferred embodiment of the present invention and various data are stored, and stores sound source output source data including sound source output touch area R1 information, which is set to be matched with a shape of the person's image I1 within an entire touch area of the touch panel 120, and sound source setting information of sound source data, which is matched with each of the sound source output touch areas R1, and the sound source data. In addition, position coordinate information on each of the touch cells 121 composing the touch panel 120 is stored in the memory unit 130, such that the control circuitry 140 can determine the position coordinates of the touch cells 121, which has generated a sensing signal, by using the stored position coordinate information.

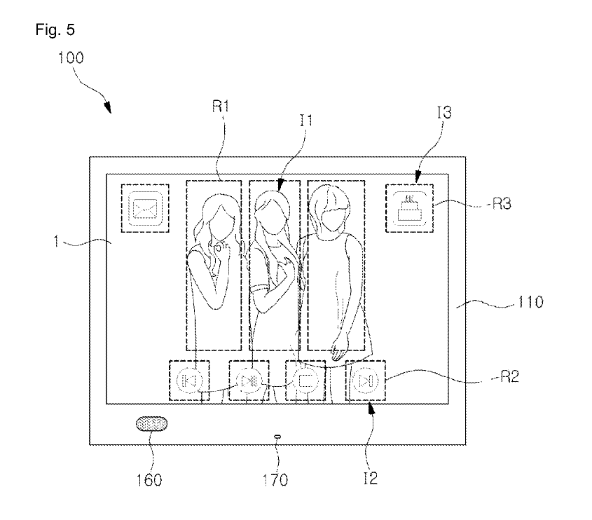

In the meantime, the sound source output touch area R1 information is the setting information on the touch area and is classified to be assigned by a user to enable different sound source data to be outputted according to the area where the touch cells 121 for sensing the touch operation are located, and can be set to be matched with external shapes of each of the person's images 11 as shown in FIG. 5. Here, although the sound source output touch area R1 is illustrated as a rectangular block area for roughly classifying the external shape of the person's image I1, the present invention is not limited to this example and it is possible that the sound source output touch area R1 can be formed in the same curved elliptic shape as the external shape of each of the person's images 11. And the sound source setting information means the setting information on each of the respective sound source output touch areas R1 matched with the at least one sound source data such that prestored specific sound source data is outputted through the speaker unit 160, when the touch signal is generated from the touch cells 121 included in each of the set sound source output touch areas R1.

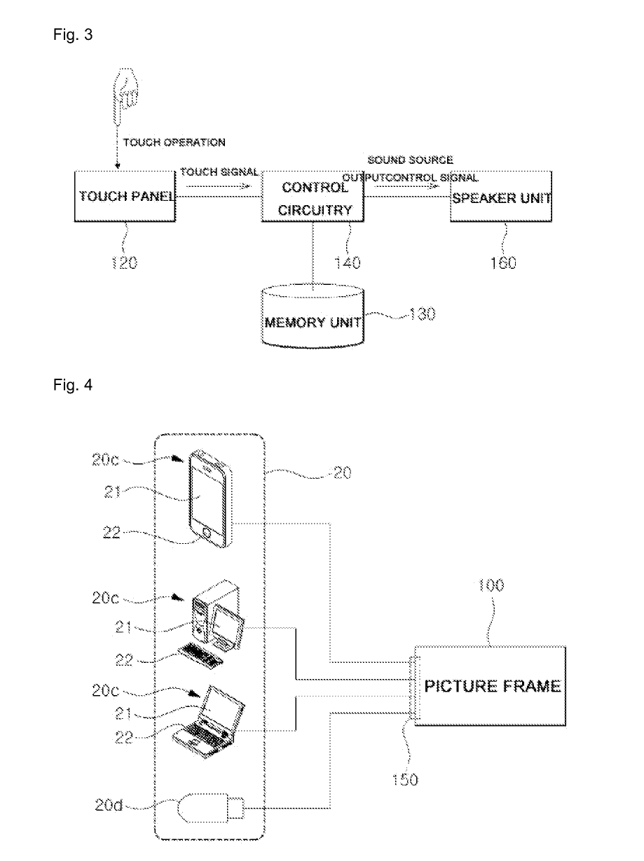

The control circuitry 140 is a control circuit which performs a centralized control such that preset sound source data is automatically outputted through the speaker unit 160 on the basis of the touch signal generated from the touch panel 120 by using the respective position coordinate information of the touch cells 121 composing the touch panel 120, reads the sound source output source data, which is inputted through the interface unit 150 or stored, and outputs a voice output control signal such that the sound source data, which is stored to be matched with the corresponding sound source output touch area R1, can be outputted through the speaker unit 160 according to the sound source setting information, when the touch signal is received from the touch cells 121 included in the sound source output touch area R1 on the basis of the position coordinates of the touch cells 121 which have sensed the touch operation as shown in FIG. 3.

Therefore, as shown in FIG. 5, the photograph 10 including three person's images 11 is contained in the photograph frame 100, three sound source output touch areas R1 classified for respective persons are set in the memory unit 130, touch cells 121 of the touch panel 120 arranged on a touched position are sensed to generate the touch signal, when the user touches (pressurizes) an arbitrary position within an arbitrary sound source output touch area R1 among the set sound source output touch areas R1 on the photograph 10, and the touch signal is sent to the control circuitry 140.

Also, the control circuitry 140 determines a touch position, where the touch operation has been performed, within the overall touch area of the touch panel 120 through the position coordinates of the touch cells 121, which have generated the touch signal, by using the position coordinate information for respective touch cells 121 stored in the memory unit 130, and controls the sound source data, which is stored to be matched with the corresponding sound source output touch area R1, to be read from the memory unit 130 and outputted through the speaker unit 160, when the position coordinates of the corresponding touch cells 121 are included in the preset sound source output touch area R1, such that the sound source for the corresponding person's image I1 can be outputted to outside.

The interface unit 150 is an electrical connecting means provided to be connected to an interface device 20, and provides a function of receiving the sound source output source data and the sound source data delivered from the interface device 20 and delivering the received data to the memory unit 130, and the memory unit 130 stores the delivered sound source output source data and the sound source data.

Here, the interface device 20 is an electronic communication device in a comprehensive meaning including both a client terminal operated by a user, on which a program for generating sound source output source data to be inputted to the photograph frame 100 is installed and executed, as well as an external memory, on which the sound source output source data generated by the client terminal is stored: as shown in FIG. 4, the client terminal can include a display means 21 for displaying an operation screen such as a smartphone 20a, a personal computer (PC) 20b, and a notebook 20c, and a terminal having an input means 22 for outputting a user input signal, and the external memory can include a data storage medium 20d such as a universal serial bus (USB) stick, a secure digital (SD) card, a digital versatile disk (DVD), a compact disk (CD), etc. Therefore, the interface unit 150 can be implemented in various ways as a USB port, a connector such as 5-pin, 8-pin, and 20-pin connectors, a DVD read only memory (ROM), and a CD ROM according to the signal-coupled interface device 20.

The microphone unit 170 is an input means which collects sound waves of a voice of a user to generate the sound source data in an electrical signal according to a vibration of the voice, and the sound source data generated in the microphone unit 170 is stored in the memory unit 130. Also, the control circuitry 140 can set the sound source data generated by the microphone unit 170 to be matched with the sound source output touch area R1 set by the user and can control the recorded sound source data to be outputted when the touch signal is received from the touch cells 121 included in the sound source output touch area R1.

Since the voice of the user or music can be recorded in real time without using the interface device 20 by way of the configuration of the microphone unit 170, and the generated sound source data can be stored to be matched with a specific person as the sound source data of the person, the process of matching the sound source data with the image of the person can be performed more easily.

In the meantime, although an input button for generating a user input signal can be provided on the case 110 to control an output of the sound source data of the photograph frame 100, it is possible to form a control button area within the touch area of the touch panel 120 as the user prefers without arranging the input button on the case 110, and control various operations of the photograph frame 100 through the control button area.

In order to accomplish this, at least one control button image I2 is included in the photograph 10, and the memory unit 130 further stores control signal executing source data including control signal output touch area R2 information, which is set to be matched with a shape of the control button image I2 within the entire touch area of the touch panel 120, and control setting information of the control signal, which is matched with each of the control signal output touch areas R2, and the control signal.

Also, the control circuitry 140 is programmed to execute a function according to content of the control signal matched with the corresponding control signal output touch area R2 according to the control setting information, when the touch signal is received from the touch cells 121 included in the control signal output touch area R2 on the basis of the position coordinates of the touch cells 121 which have sensed the touch operation of the user.

To be more specific, when the same sound source data is to be outputted after the sound source data was outputted according to a touch on the person's image I1, or when a plurality of sound source data are matched with one person's image I1 and desired sound source data is to be selectively played, a control signal for controlling the desired operation is required, and the user can arrange the control button image I2 of a desired shape along with the person's image I1 on the photograph 10 using a separate editing program or a program according to a preferred embodiment of the present invention.

Also, a desired function can be allocated to a touch area of the touch panel 120 where the control button image I2 is arranged, that is, the control signal output touch area R2. For example, as shown in FIG. 1, various control functions such as a front control button image for outputting the sound source data arranged before the sound source data currently outputted, a play stop control button image for stopping and resuming the playback of the current sound source data, and a back control button image for outputting the sound source data arranged after the current sound source data, etc. can be set to be matched with the allocated functions.

Therefore, when an arbitrary person's image I1 is touched and the sound source data corresponding to the person's image I1 is outputted, an output state of the sound source data can be easily manipulated according to a will of the user by simply touching the control button image.

As such, external beauty of the photograph frame 100 can be improved and the manufacturing cost for fabricating the input button can be reduced since it is possible to allocate areas for implementing same functions as input buttons on the touch panel 120 without arranging the input button such as a conventional push button is separately provided on the case 110. Also, since the user can arrange the control button images I2 within the entire touch area to allocate the control signal output touch area R2 as he/she desires, creative photograph frames 100 can be realized for respective users.

Meanwhile, the photograph frame 100 can be provided to arbitrarily output the sound source data desired by the user separately from the person's image 11 and in order to accomplish this, at least one icon image I3 is included in the photograph 10; the memory unit 130 further stores sound source output source data including output touch area R3 information, which is set to be matched with a shape of the icon image I3 within the entire touch area of the touch panel 120, and sound source setting information of the sound source data, which is matched with each of the sound source output touch areas R3, and the control signal, and the control circuitry 140 is programmed to output a sound source output control signal for enabling the sound source data matched with the corresponding sound source output touch area R3 to be outputted according to the sound source setting information when the touch signal is received from the touch cells 121 included in the sound source output touch area R3 on the basis of position coordinates of the touch cells 121 which have sensed the touch operation.

More specifically, the user can arrange the icon image I3 of a desired shape along with the person's image I1 on the photograph 10 using a separate editing program or a program according to a preferred embodiment of the present invention, and can set the sound source output touch area R3 to be matched with the touch area of the touch panel 120 where the icon image I3 is arranged.

Therefore, when the user touches the icon image I3 in a message type as shown in FIG. 1, a prestored message voice can be outputted as a text message separately from when the user touches the person's image, and when the user touches the icon image I3 in a cake shape, a birthday celebration song or music can be outputted: that is, predetermined sound source data matched with the icon image I3 can be arbitrarily outputted.

As such, since the user can arrange the icon image I3 and sound source data which he/she desires, on a desired position on the photograph separately from the sound source data according to the person's image I1, various sound source data can be provided, which maximize utilization of the photograph frame 100 and convenience of the user.

In the meantime, in order to output the sound source data matched with the desired person's image I1 or the icon image I3 or execute a function according to the control signal matched with the control button image I2 in the photograph frame 100, it is required to touch or pressurize the upper surface of the photograph 10 by using a user's finger or a touch pen, and since a surface of the photograph 10 is exposed to outside, it can be easily contaminated by foreign matters such as dusts and moistures.

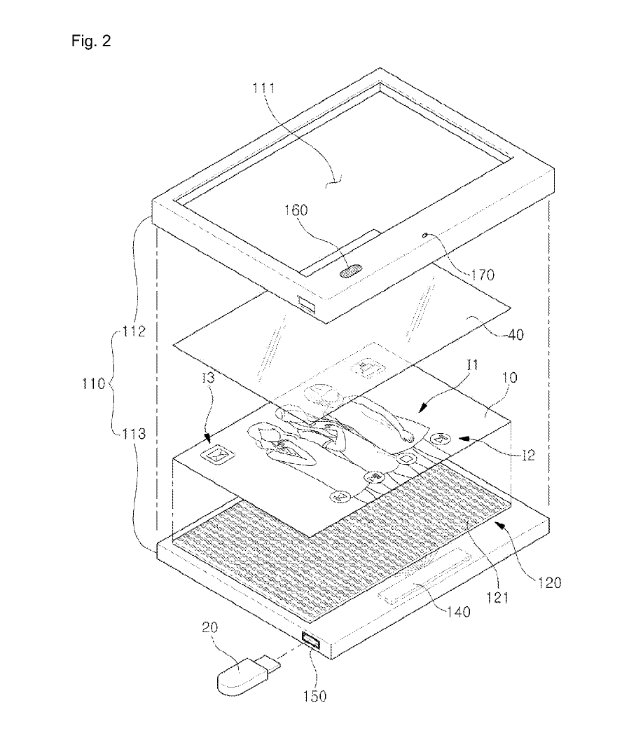

In order to solve this problem, the photograph frame 100 according to a preferred embodiment of the present invention can further comprises a skin sheet unit 40 which is secured on the photograph to cover the upper surface of the photograph 10 secured on the touch panel 120, as shows in FIG. 2. Here, the skin sheet unit 40 is made of a transparent or semitransparent material, such that the user can view the image of the photograph 10 from outside.

Here, the control button image I2 and the icon image I3 are illustrated to be arranged along with the person's image I1 on the photograph 10, however, the control button image I2 or the icon image I3 can be arranged to be printed on the skin sheet unit 40 rather than along with the photograph 10.

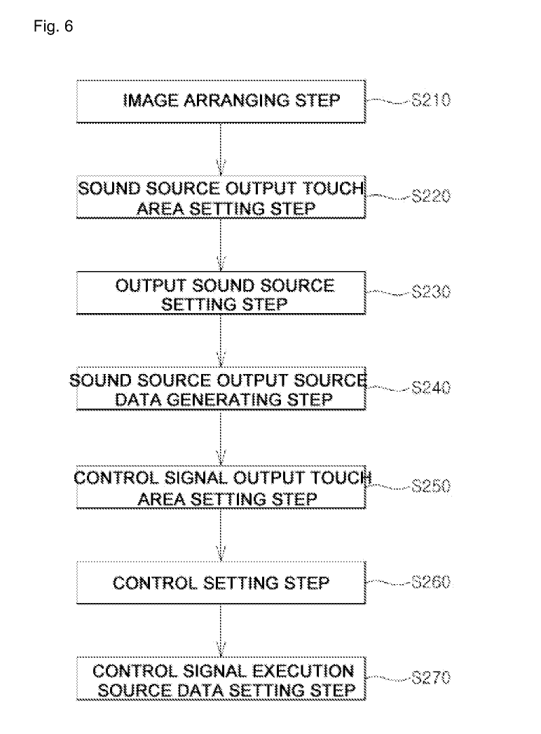

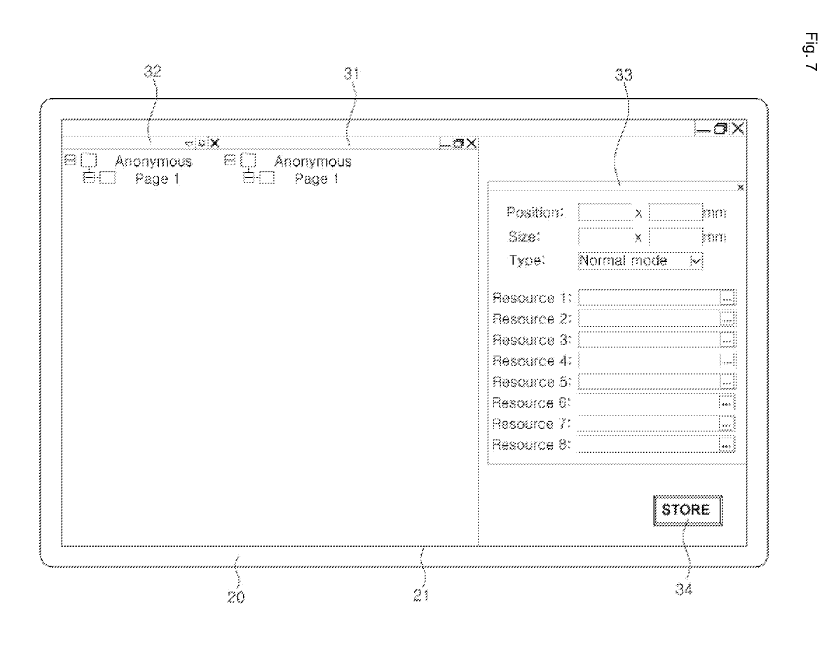

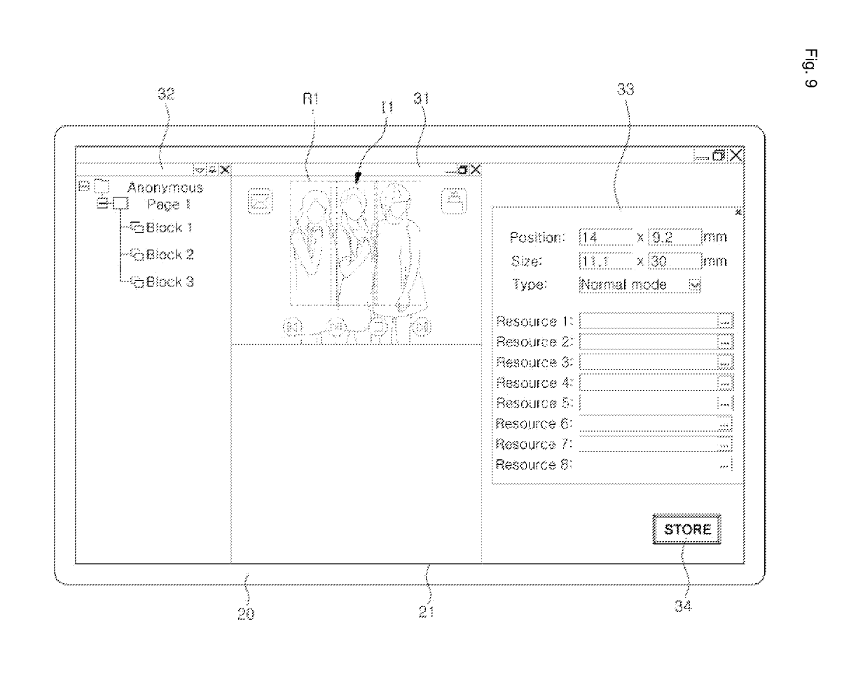

Next, the recording medium storing a program for generating the sound source output source data to be inputted to the photograph frame 100 according to a preferred embodiment of the present invention by referring to FIGS. 6 to 14.

In FIGS. 6 to 14, illustrated are the steps for generating desired sound source output source data through the display means 21 and the input means 22 of the interface device 20 by installing and executing the program on the interface device 20 through the recording medium storing the program for generating the sound source output source data, according to a preferred embodiment of the present invention.

As shown in FIG. 6, the recording medium storing therein a program for generating sound source output source data according to a preferred embodiment of the present invention stores a program to be executed on a computer (interface device 20), comprising an image arranging step S210, a sound source output touch area setting step S220, an output sound source setting step S230, a sound source output source data generating step S240, a control signal output touch area setting step S250, a control setting step S260, and a control signal executing source data generating step S270, wherein the stored program is stored and executed on the interface device 20, and program screens are displayed on the display means 21 where screen windows for corresponding interface devices 20 are displayed, such that the user can generate and store the sound source output source data, the control signal output source data, and the sound source data to be inputted to the photograph frame 100 through the interface device 20.

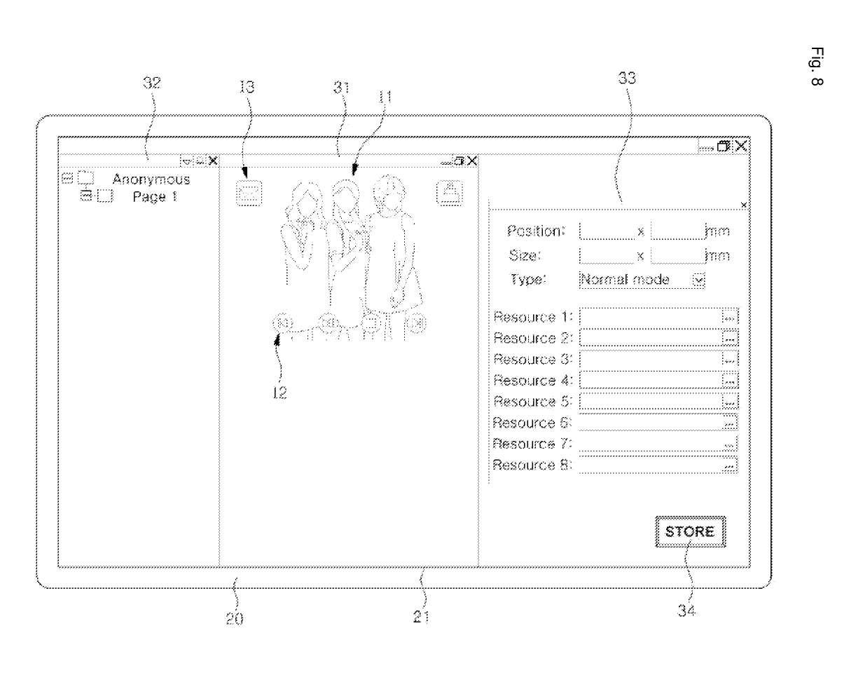

Here, when the program installed on the interface device 20 is executed, the display means 21 of the interface device 20 is operated to display the screen window as shown in FIG. 7. The display means 21 is shown to include: a touch area window 31 to which position coordinate information corresponding to the entire touch area of the touch panel 120 is mirrored; a separate touch area setting window 32 which is matched with a person's image I1 the user desired inside the image of the arranged photograph 10 to display items for setting the predetermined sound source output touch areas R1, R3 and the control signal output touch area R2; a separate signal setting window 33 which displays items for setting the sound source data matched with each of the set sound source output touch areas R1, R3 and the control signal output touch area R2, and the control signal; and a storage block 34 which stores the respective settings set through the sound source output touch area setting step S220, the output sound source setting step S230, the control signal output touch area setting step S250, and the control setting step S260 to generate final sound source output source data and control signal executing source data.

At first, the image arranging step S210 is a step in which the image data of the photograph 10 including at least one person's image I1 is read and the image of the photograph 10 in the touch area window 31 is arranged within the touch area window 31, that is, the set touch area range of the touch panel 120 on the display means 21 of the interface device 20; when the user selects (clicks on) the touch area window 31 by using the input means 22 such as a touch screen of the interface device 20, a keyboard, or a mouse, etc., a search window for selecting and setting the image data of the desired photograph 10 from various data stored in the interface device 20 is popped up, and, when the image data of the arbitrary photograph 10 is set through the search window, the image of the corresponding photograph 10 is arranged to be matched with a size of the touch area window 31.

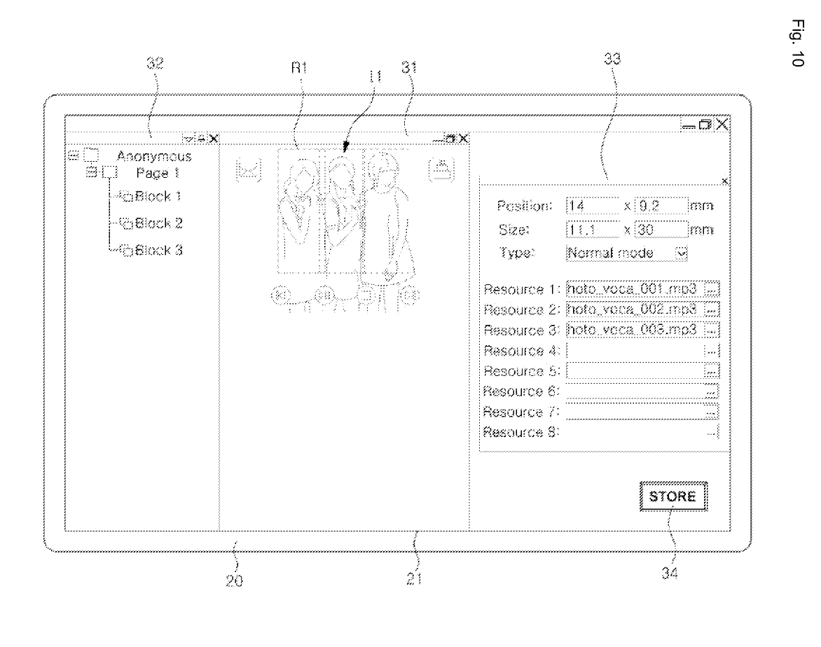

The sound source output touch area setting step S220 is a step in which the sound source output touch area R1, which is matched with the shape of the person's image I1, is set on the basis of the position coordinates of the touch cells 121 in the touch area of the touch panel 120 where the image of the photograph 10 is arranged according to the user input signal of the interface device 20; when the user selects the desired setting area by dragging each of the person's images 11 on the image of the photograph 10 arranged in the touch area window 31 by using the input means 22 of the interface device 20, as shown in FIG. 9, the sound source output touch area R1 set for each of the person's images 11 is displayed on the touch area window 31, and since the image of the corresponding photograph 10 is arranged to be matched with the size of the touch area window 31, the position coordinate information of the set sound source output touch area R1 can be displayed on the separate touch area setting window 32.

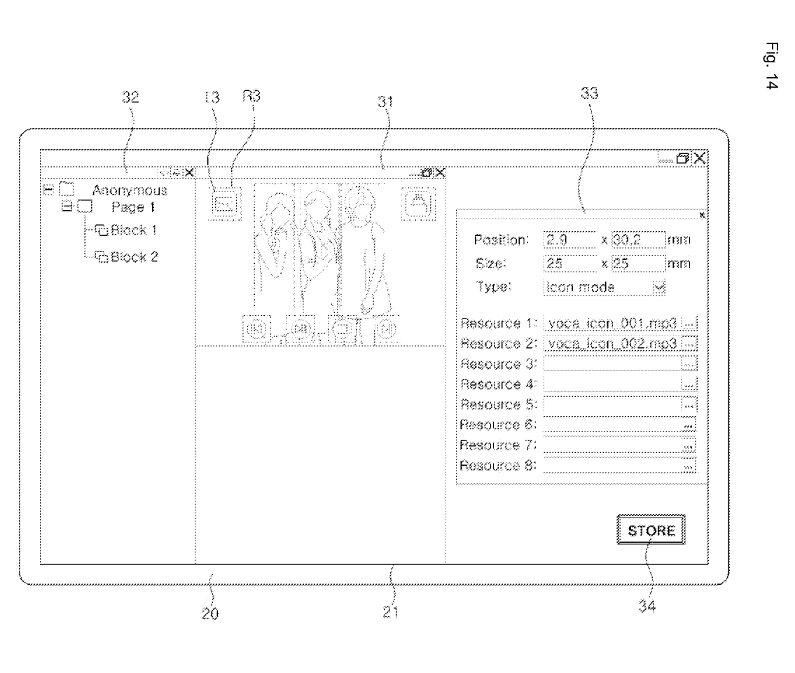

Also, when the user selects the desired setting area by dragging each of the icon images I3 on the image of the photograph 10 arranged in the touch area window 31 by using the input means 21 of the interface device 20, as shown in FIG. 13, the sound source output touch area R3 set for each of the icon images I3 is displayed on the touch area window 31, and since the image of the corresponding photograph 10 is arranged to be matched with the size of the touch area window 31, the position coordinate information of the set sound source output touch area R3 can be displayed on the separate touch area setting window 32.

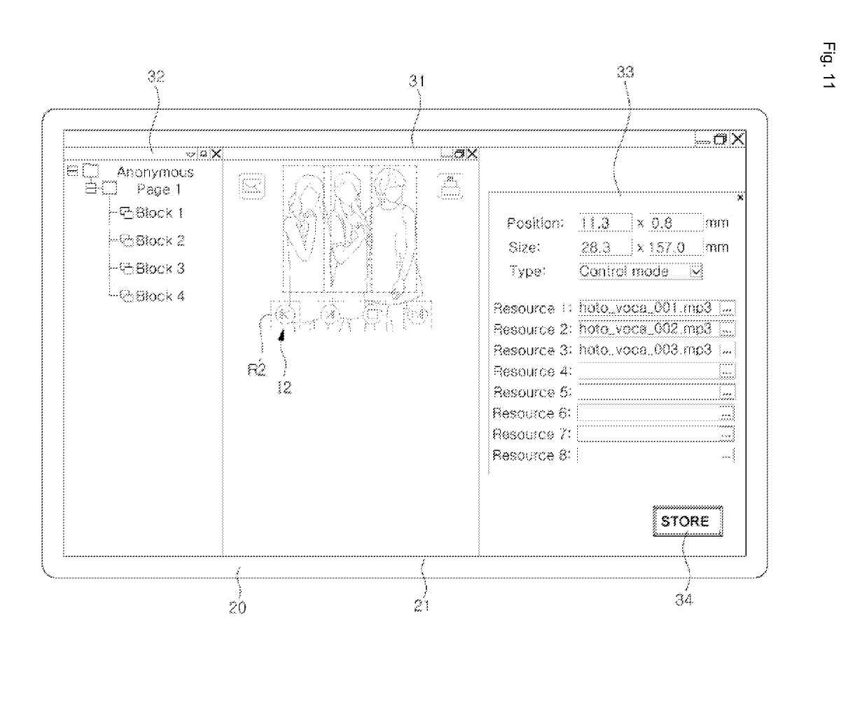

The output sound source setting step S230 is a step in which the sound source data, which is matched with each of the sound source output touch areas R1, is set among the stored sound source data according to the user input signal; when the user selects the separate signal setting window 33 by using the interface device 20 as shown in FIG. 10, a search window for selecting and setting the desired sound source data from the various data stored in the interface device 20 is popped up, the desired arbitrary source data is set to be matched with the preset sound source output touch area R1 through the search window, the set content is displayed on the separate signal setting window 33.

Also, when the user selects the separate signal setting window 33 by using the interface device 20 as shown in FIG. 14, a search window for selecting and setting the desired sound source data from the various data stored in the interface device 20 is popped up, the arbitrary source data is set to be matched with the preset sound source output touch area R3 through the search window, the set content is then displayed on the separate signal setting window 33.

The sound source output source data generating step S240 is a step in which the respective setting information set through the sound source output touch area setting step S220 and the output sound source setting step S230 is stored to generate the sound source output source data; when the user checks the set content of the sound source output touch areas R1, R3 displayed on the touch area window 31 and the set content of the sound source data displayed on the separate signal setting window 33 and selects the storage block 34 included in the display means 21, the sound source output source data, including the sound source output touch area R1 information which is set to be matched with the shape of the person's image I1 as the respective set items are stored and the sound source setting information for the sound source data matched with each of the sound source output touch areas R1, is generated, and, at the same time, the sound source output touch area R3 information which is set to be matched with the shape of the respective icon images I3 and the sound source setting information for the sound source data matched with each of the sound source output touch areas R3 is stored.

The generated sound source output source data is stored on the interface device 20, and the user can input and store the sound source output source data, which is generated while the interface device 20 is interconnected with the photograph frame 100 via the interface unit 150, to and on the memory unit 130 of the photograph frame 100.

Also, when the interface device 20 is a client terminal such as a smartphone 20a, a personal computer (PC) 20b, or a notebook 20c, etc., the external memory 20d can be connected to the client terminal to transfer the sound source output source data to the external memory 20d and stored; on the other hand, the external memory 20d can be connected to the interface unit 150 of the photograph frame 100 such that the stored sound source output source data can be directly inputted to or stored on the memory unit 130.

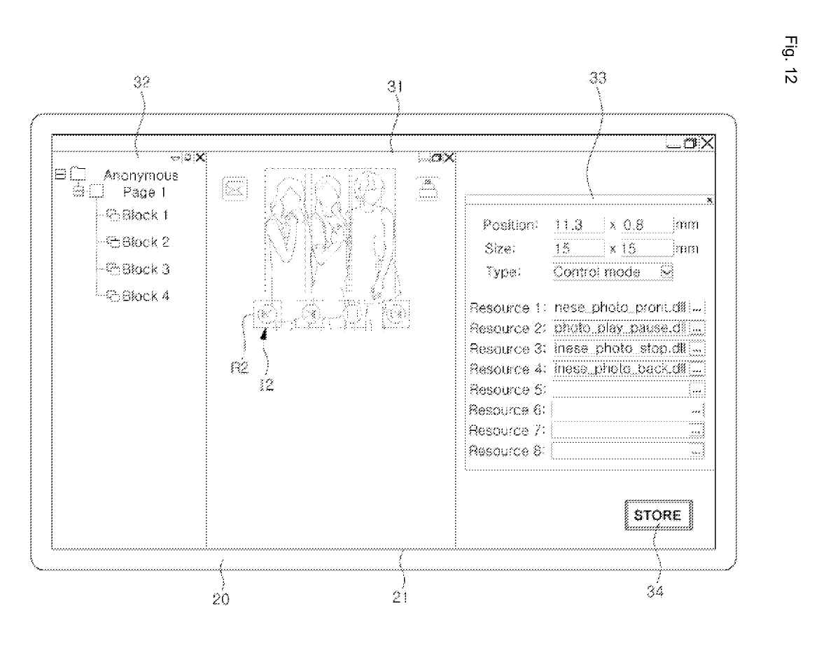

The control signal output touch area setting step S250 is a step in which the control signal output touch area R2, which is matched with the shape of the control button image I2, is set on the basis of the position coordinates of the touch cells 121 in the touch area of the touch panel 120 where the image of the photograph 10 is arranged according to the user input signal of the interface device 20; when the user selects the desired setting area by dragging each of the control button images I2 on the image of the photograph 10 arranged in the touch area window 31 by using the input means 22 of the interface device 20, as shown in FIG. 11, the control signal output touch area R2 set for each of the control button images I2 is displayed on the touch area window 31, and since the image of the corresponding photograph 10 is arranged to be matched with the size of the touch area window 31, the position coordinate information of the set control signal output touch area R2 can be displayed in the separate touch area setting window 32.

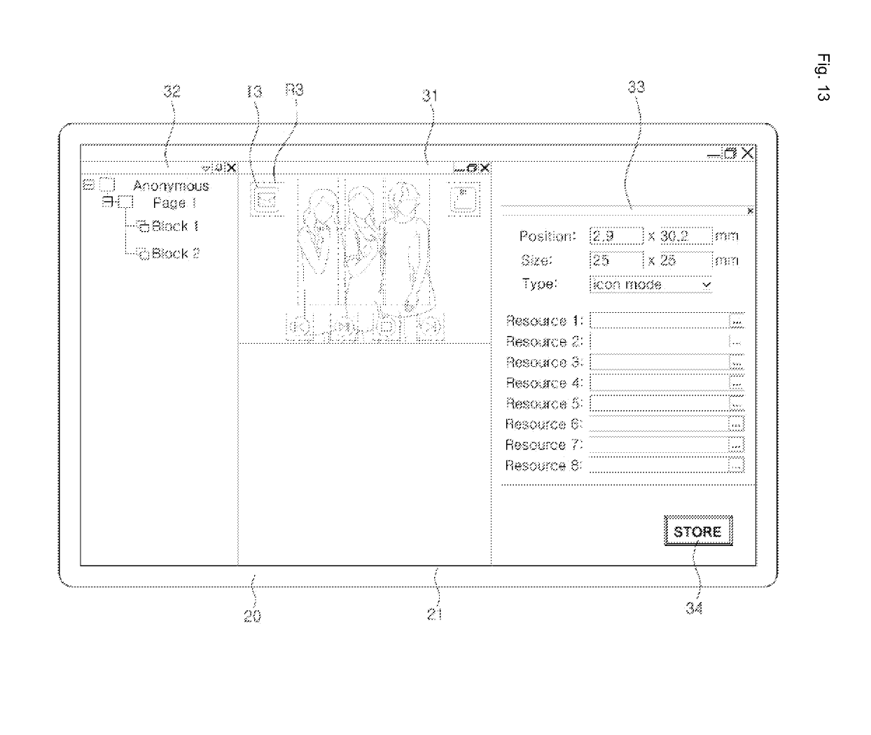

The control setting step S260 is a step of setting a control signal which is matched with each of the control signal output touch areas R2; when the user selects the separate signal setting window 33 by using the interface device 20 as shown in FIG. 12, a search window for selecting and setting the control signal for the function of manipulation on the photograph frame 100 is popped up separately from the search window for selecting and setting the sound source data, an arbitrary control signal is set to be matched with the preset control signal output touch area R2 through the search window, and the set content is displayed in the separate signal setting window 33.

The control signal executing source data generating step S270 is a step of storing the respective setting information set through the control signal output touch area setting step S250 and the control setting step S260 and generating the control signal executing source data; when the user checks the set content of the control signal output touch area R2 displayed in the touch area window 31 and the separate touch area setting window 32 as well as the control signal setting content displayed in the separate signal setting window 33 and selects the storage block 34 displayed on the display means 21, control signal executing source data including control setting information of the control signal matched with each of the control signal output touch areas R2, which are set to be matched with the shape of the control button image I2 when the respective set items are stored, is generated.

And, the generated control signal executing source data is stored on the interface device 20, and the user can input and store the control signal executing source data, which is generated while the interface device 20 is interconnected with the photograph frame 100 via the interface unit 150, to and on the memory unit 130 of the photograph frame 100.

Here, although the sound source output source data and the control signal executing source data are explained to be generated separately, it is to be understood that the sound source output source data and the control signal executing source data can be generated simultaneously by selecting the storage block 34 included in the display means 21 after all setting items are set for the sound source data and the control signal through the sound source output touch area setting step S220, the output sound source setting step S230, the control signal output touch area setting step S250, and the control setting step S260.

According to the photograph frame 100 having a sound source output function and the recording medium recording a program for generating sound source output source data to be inputted to the photograph frame 100 according to a preferred embodiment of the present invention, since the photograph frame is only used for viewing printed images like normal photograph frames during a normal use, while the sound source data related to a voice of a person or preferred music is automatically outputted, when the user touches the corresponding person's image I1 of the photograph 10 contained in the frame, the sense of realism at that time can be vividly reproduced, and since image can be viewed without using an expensive liquid crystal panel, manufacturing cost and maintenance cost can be reduced.

Furthermore, since the sound source data related to the corresponding person is matched with the person included in a photograph 10, stored, and outputted, the sound source of the person who the user prefers can be selectively played, thereby maximizing user convenience.

Also, since the program for generating the sound source output source data to be inputted to the photograph frame 100 is installed and executed on the interface device 20 such as a smartphone 20a, a PC 20b, and a notebook 20c, etc., and the interface device 20 is connected via the interface unit 150 of the photograph frame 100 to set the sound source output touch areas R1 for the respective persons included in the photograph 10 on the screen and matches the sound source output touch areas R1 with desired sound source data, even when the photograph 10 contained in the photograph frame 100 is changed, setting of the sound source output function can be easily changed according to the person in the corresponding photograph 10, thereby maximizing user convenience.

The present invention described above is not limited to the aforementioned embodiments and the appended figures, and it would be understood by those persons with an ordinary skill in the field to which the present invention pertains that various replacements, variations, and modifications can be made without departing from the spirit of the present invention.

1. A photograph frame having a sound source output function, comprising:
a case 110 having therein a space unit 111 for receiving a photograph 10 in which at least one person's image I1 is included;
a touch panel 120 which is secured inside the case 110, wherein the photograph 10 is secured on the upper part of the touch panel 120 in a stacked manner, and the touch panel 120 comprises a plurality of touch cells 121 which sense a user's touch operation being input through an upper surface of the photograph 10 and generate a touch signal;
a memory unit 130 in which sound source output source data including sound source output touch area R1 information, which is configured to be matched with a shape of the person's image I1 within an entire touch area of the touch panel 120, and sound source setting information of sound source data, which is matched with each of the sound source output touch areas R1, and the sound source data are stored;
a control circuitry 140 for reading the sound source output source data stored in the memory unit 130, and outputting a sound source output control signal which enables the sound source data that is matched with the corresponding sound source output touch area R1 to be outputted according to the sound source setting information when the touch signal is received from the touch cells 121 included in the sound source output touch area R1 on the basis of position coordinates of the touch cells 121 which have sensed the touch operation; and
a speaker unit 160 for outputting the sound source data according to the control signal of the control circuitry 140.

2. The photograph frame having a sound source output function according to claim 1, characterized in that:
at least one control button image I2 is included in the photograph 10,
the memory unit 130 further stores control signal executing source data including control signal output touch area R2 information, which is set to be matched with a shape of the a control button image I2 within the entire touch area of the touch panel 120, and control setting information of the control signal, which is matched with each of the control signal output touch areas R2, and the control signal, and
the control circuitry 140 executes a function according to content of the control signal matched with the corresponding control signal output touch area R2 according to the control setting information when the touch signal is received from the touch cells 121 included in the control signal output touch area R2 on the basis of position coordinates of the touch cells 121 which have sensed the touch operation.

3. The photograph frame having a sound source output function according to claim 1, characterized in that:
the photograph frame further comprises a skin sheet unit 40 made of a transparent or semitransparent material which is secured on the photograph to be stacked on the photograph 10 and covers the upper surface of the photograph 10 secured on the touch panel 120, and at least one icon image I3 is formed on the skin sheet unit 40,
wherein the memory unit 130 further stores sound source output source data including output touch area R3 information, which is set to be matched with a shape of the icon image I3 within the entire touch area of the touch panel 120, and sound source setting information of the sound source data, which is matched with each of the sound source output touch areas R3, and the control signal, and
the control circuitry 140 outputs a sound source output control signal for enabling the sound source data matched with the corresponding sound source output touch area R3 to be outputted according to the sound source setting information when the touch signal is received from the touch cells 121 included in the sound source output touch area R3 on the basis of position coordinates of the touch cells 121 which have sensed the touch operation.

4. Recording medium storing therein a program for generating sound source output source data to be inputted to the photograph frame 100 according to claim 1, wherein the program is executed on a computer to perform:
an image arranging step S210 in which image data of a photograph 10 including at least one person's image I1 is read and an image of the photograph 10 is arranged in a set touch area range of the touch panel 120 on a screen of an interface device 20;
a sound source output touch area setting step S220 in which a sound source output touch areas R1, which is matched with a shape of the person's image I1, is set on the basis of position coordinates of touch cells 121 within a touch area of the touch panel 120 on which the image of the photograph 10 is arranged according to a user input signal from the interface device 20;
an output sound source setting step S230 in which sound source data, which is matched with each of the sound source output touch areas R1 of the person's image I1, is set among prestored sound source data according to the user input signal; and
a sound source output source data generating step S240 in which the setting information, which is set in the sound source output touch area setting step S220 and the output sound source setting step S230, is stored to generate the sound source output source data.

5. Recording medium storing therein a program for generating sound source output source data to be inputted to the photograph frame 100 according to claim 2, wherein the program is executed on a computer to perform:
an image arranging step S210 in which image data of a photograph 10 including at least one person's image I1 is read and an image of the photograph 10 is arranged in a set touch area range of the touch panel 120 on a screen of an interface device 20;
a sound source output touch area setting step S220 in which a sound source output touch areas R1, which is matched with a shape of the person's image I1, is set on the basis of position coordinates of touch cells 121 within a touch area of the touch panel 120 on which the image of the photograph 10 is arranged according to a user input signal from the interface device 20;
an output sound source setting step S230 in which sound source data, which is matched with each of the sound source output touch areas R1 of the person's image I1, is set among prestored sound source data according to the user input signal; and
a sound source output source data generating step S240 in which the setting information, which is set in the sound source output touch area setting step S220 and the output sound source setting step S230, is stored to generate the sound source output source data.

6. Recording medium storing therein a program for generating sound source output source data to be inputted to the photograph frame 100 according to claim 3, wherein the program is executed on a computer to perform:
an image arranging step S210 in which image data of a photograph 10 including at least one person's image I1 is read and an image of the photograph 10 is arranged in a set touch area range of the touch panel 120 on a screen of an interface device 20;
a sound source output touch area setting step S220 in which a sound source output touch areas R1, which is matched with a shape of the person's image I1, is set on the basis of position coordinates of touch cells 121 within a touch area of the touch panel 120 on which the image of the photograph 10 is arranged according to a user input signal from the interface device 20;
an output sound source setting step S230 in which sound source data, which is matched with each of the sound source output touch areas R1 of the person's image I1, is set among prestored sound source data according to the user input signal; and
a sound source output source data generating step S240 in which the setting information, which is set in the sound source output touch area setting step S220 and the output sound source setting step S230, is stored to generate the sound source output source data.
